(19) United States
(12) Patent Application Publication
(10) Pub. No.: US 2006/0139354 A1
(43) Pub. Date: Jun. 29, 2006

(54) Operation instruction method, operation instruction device, electronic device, and computer product

(75) Inventor: Daisuke Suma, Tokyo (JP)

Correspondence Address: FOLEY AND LARDNER LLP;SUITE 500, 3000 K STREET NW, WASHINGTON, DC, 20007, US

(73) Assignees: PIONEER CORPORATION; PIONEER DESIGN CORPORATION

(21) Appl. No.: 11/296,700

(22) Filed: Dec. 8, 2005

(30) Foreign Application Priority Data
Dec. 9, 2004 (JP) 2004-356626

(51) Int. Cl. G06T 15/70

(52) U.S. Cl. 345/473

(57) ABSTRACT

An operation instruction device includes a display control unit, an accepting unit, and an executing unit. The display control unit repeatedly displays, on a display screen, at least one animation indicative of contents of an operation to be executed. The accepting unit accepts designation of an animation made by a user from among the animation displayed. The executing unit executes, based on the designation, an operation indicated by designated animation. The animation visually indicates the operation by showing the operation being performed by a person or an anthropomorphic animal appearing as the operator.

### BACKGROUND OF THE INVENTION

1. Field of the Invention

The present invention relates to a technology for instructing operation in a device.

2. Description of the Related Art

Conventionally, animation icons have been used in an operation menu displayed on a display of electronic devices. Such a technology is disclosed in, for example, Japanese Published Unexamined Patent Application No. H10-124288, Japanese Published Unexamined Patent Application No. H11-55594, Japanese Published Unexamined Patent Application No. 2003-256104. Moreover, a technology for animation icons to help easy understanding of contents of video files is disclosed in, for example, Japanese Patent Application No. H10-60097.

However, it is difficult for an operator to understand contents only with a single image shown by the animation icon. Therefore, the conventional animation icons can make the operator misunderstand what an icon indicates. As a result, the operator can make a wrong selection. To avoid a wrong selection, the operator still has to refer to a help screen or a manual.

In addition, in recent years, global designs that can be commonly used around the world beyond languages have been attracting attention.

### SUMMARY OF THE INVENTION

It is an object of the present invention to at least solve the above problems in the conventional technology.

An operation instruction device according to one aspect of the present invention includes a display control unit configured to repeatedly display, on a display screen, at least one animation indicative of contents of an operation to be executed; an accepting unit configured to accept designation of an animation from among the animation displayed; and an executing unit configured to execute, based on the designation, an operation indicated by designated animation.

An electronic device according to another aspect of the present invention includes the operation instruction device according to the above aspect.

An operation instruction method according to still another aspect of the present invention includes displaying, on a display screen, at least one animation indicative of contents of an operation to be executed, repeatedly; accepting designation of an animation from among the animation displayed; and executing, based on the designation, an operation indicated by designated animation.

A computer-readable recording medium according to still another aspect of the present invention stores therein a computer program for realizing an operation instruction method according to the above aspect.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of an operation instruction device according to an embodiment of the present invention;

FIG. 2 is a flowchart of a processing in the operation instruction device;

FIG. 3 is a block diagram of an operation instruction device according to an example of the present invention;

FIG. 4 is a schematic of an animated image indicating “editing” operation;

FIG. 5 is a schematic of an animated image indicating “deleting” operation;

FIG. 6 is a schematic of an animated image indicating “setting” operation;

FIG. 7 is a schematic of an animated image indicating “image quality selecting” operation;

FIG. 8 is a schematic of an animated image indicating “recording destination selecting” operation;

FIG. 9A is a flowchart of a first processing in an operation instruction device according to an example of the present invention;

FIG. 9B is a flowchart of a second processing in the operation instruction device;

FIG. 9C is a flowchart of a third processing in the operation instruction device;

FIG. 10 is a schematic of a display screen displayed in the operation instruction device;

FIG. 11 is a schematic of a display screen displayed in the operation instruction device;

FIG. 12 is a schematic of a display screen displayed in the operation instruction device;

FIG. 13 is a schematic of a display screen displayed in the operation instruction device; and

FIG. 14 is a schematic of a display screen displayed in the operation instruction device.

### DETAILED DESCRIPTION OF THE PREFERRED EMBODIMENTS

Exemplary embodiments according to the present invention will be explained in detail with reference to the accompanying drawings.

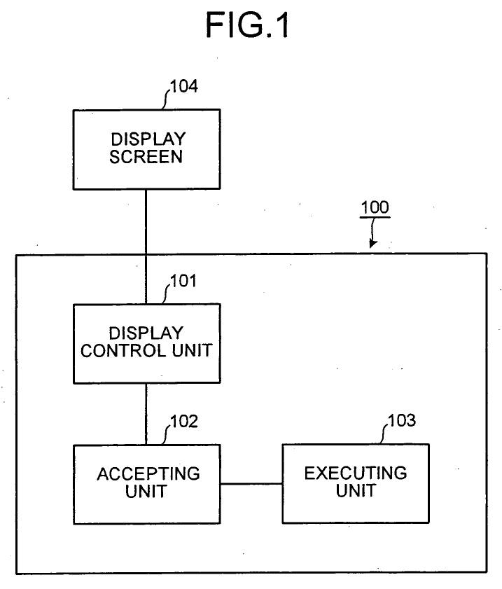

FIG. 1 is a block diagram of an operation instruction device according to an embodiment of the present invention. As shown in FIG. 1, an operation instruction device 100 includes a display control unit 101, an accepting unit 102, and an executing unit 103.

The display control unit 101 controls a display screen 104 to repeatedly display animated images each of which shows a content of a different operation, in predetermined regions on the display screen 104. The accepting unit 102 accepts designation of an animated image that is selected from among the animated images displayed on the display screen 104.

The executing unit 103 executes an operation indicated by the animated image based on the designation. The executing unit 103 may execute an operation based on a display condition of the display screen 104 when the accepting unit 102 accepts the designation. Thus, an operator can designate an operation just by selecting an animate image while observing the animated image, whereby the operator can easily designate desirable contents of selection.

The display control unit 101 may control to freeze the animated image based on a state of display on the display screen 104 when the accepting unit 102 accepts a designation. Thus, the operator can easily recognize that selection has been completed. In addition, since the animated image is displayed in a state of freeze-frame image indicating the designated operation, the operator can easily recognize which operation the operator has selected. Thus, it is possible to prevent from making wrong selection.

The operation includes an operation that has a hierarchical structure. When an operation having a lower-level operation is selected, the display control unit 101 repeatedly displays animated images indicating the lower-level operation.

The animated image shows pictures in animation as images and movies shown on a television. Since an animated image is composed of a large number of still images (frames) that are successively displayed in a short time, for making image motions smooth, images on the order of 30 frames are used in one second. Accordingly, the animated image may be stored in a compressed state. For example, the animated image may be compressed based on an international standard system for animated image compression, such as a moving picture experts group (MPEG).

In the animated image, a person or an anthropomorphic animal may be used as a character that acts as an operator of the operation to be indicated. By showing a person or anthropomorphic animal performing the operation, it is possible to make the operator accurately understand contents of the operation. The animated image may be a cartoon, thereby making data volume small compared to that of a live-action version.

An electronic device provided with the operation instruction device according to the embodiment of the present invention includes a digital versatile disc (DVD) recorder/player, a personal computer, a mobile phone, a television system, and a car navigation system.

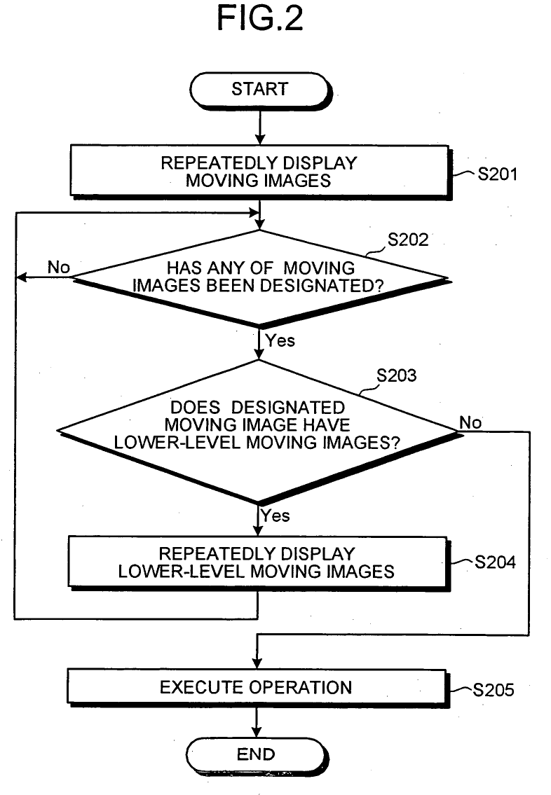

FIG. 2 is a flowchart of a processing in the operation instruction device. As shown in FIG. 2, the operation instruction device 100 repeatedly displays animated images showing different contents of operation in predetermined regions on the display screen 104 (step S201). Then, the operation instruction device 100 judges whether any of the animated images has been designated by an operator (step S202). When one of the animated images is designated (“YES” at step S202), the operation instruction device 100 judges whether designated animated image has lower-level animated images that indicate lower-level operation in the hierarchical structure (step S203).

When the designated animated image has lower-level animated images (“YES” at step S203), the operation instruction device 100 repeatedly displays the existing lower-level animated images respectively (step S204), and the process returns to step S202 to wait for designation of one of the lower-level animated images. On the other hand, when the designated animated image has no lower-level animated images (“NO” at step S203), the operation instruction device 100 executes the operation indicated by the designated animate image (step S205), and ends a series of processes.

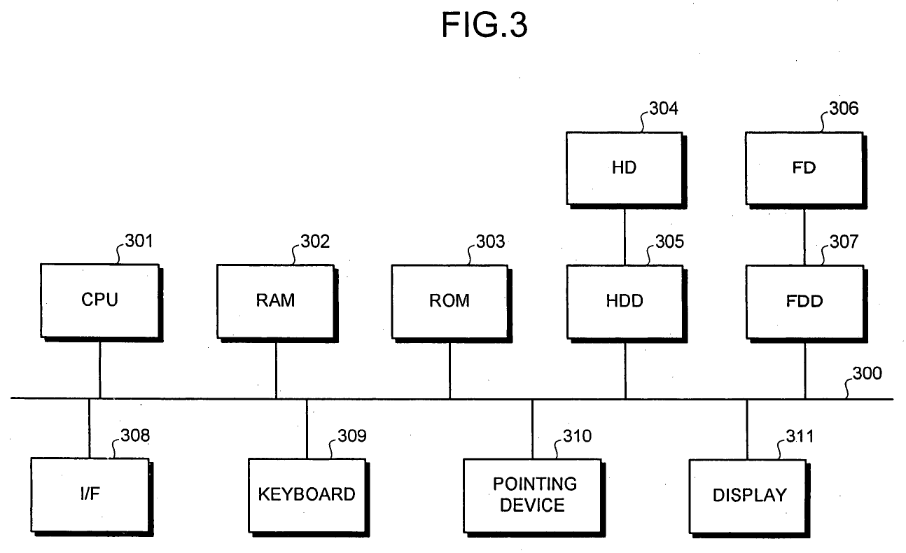

FIG. 3 is a block diagram of an operation instruction device according to an example of the present invention. As shown in FIG. 3, the operation instruction device 100 includes a central processing unit (CPU) 301, a random-access memory (RAM) 302, a read-only memory (ROM) 303, a hard disk (HD) 304, a hard disk drive (HDD) 305, a flexible disk (FD) 306 as an example of a removable recording medium, a flexible disk drive (FDD) 307, an interface (I/F) 308, a keyboard including operating buttons, a pointing device 310 including a touch panel, and a display 311.

The CPU 301 controls a whole of the operation instruction device 100. The CPU 301 also realizes a function of the display control unit 101 and the executing unit 103. The RAM 302 is used as a work area of the CPU 301. The ROM 303 stores various programs such as a boot program.

The HD 304 stores data written in accordance with a control of the HDD 305. The HDD 305 controls reading/writing of data from/to the HD 304 in accordance with a control by the CPU 301. The FD 306 stores data written in accordance with a control of the FDD 307 and allows the data to be read out into an information processor. In addition to the FD 306, a compact-disc read-only memory (CD-ROM), a compact-disk recordable (CD-R), a compact-disk rewritable (CD-RW), a magneto-optical disk (MO), a DVD, a memory card may be used as a removable recording medium. The FDD 307 controls reading/writing of data from/to the FD 306 in accordance with a control of the CPU 301.

The I/F 308 is connected to an external device, an information processor, or a network, and controls input/output of data (including program guide information) with respect to the external device, the information processor, or the network. The I/F 308 includes a modern, a local-area-network (LAN) adapter, and a connection terminal.

A keyboard 309 is provided with keys for inputting letters, numerals, various instructions and the like and allows inputting various types of information. The keyboard 309 includes operating buttons for inputting various types of data or for operation. This may be a touch panel-type input pad or a numeric keypad

The pointing device 310 performs cursor motion, range selection, and a shift and resizing of a window. The pointing device 310 may be a track ball, a joystick, a cross key, or a jog dial as long as it has a function as a pointing device. This includes a touch panel provided on the display 311.

Besides a cursor, icons, and a tool box, the display 311 displays data such as documents, images, and functional information. The display 311 may be a cathode-ray tube (CRT), a thin-film-transistor (TFT) liquid-crystal display, a plasma display, or an organic electroluminescent (EL) display. The display 311 realizes a function of the display screen 104. In a DVD recorder/player, the display may be incorporated, and data may be transmitted to a connected television via the I/F 308 so as to be displayed on the television. In this case, the connected television realizes the display screen 104 function.

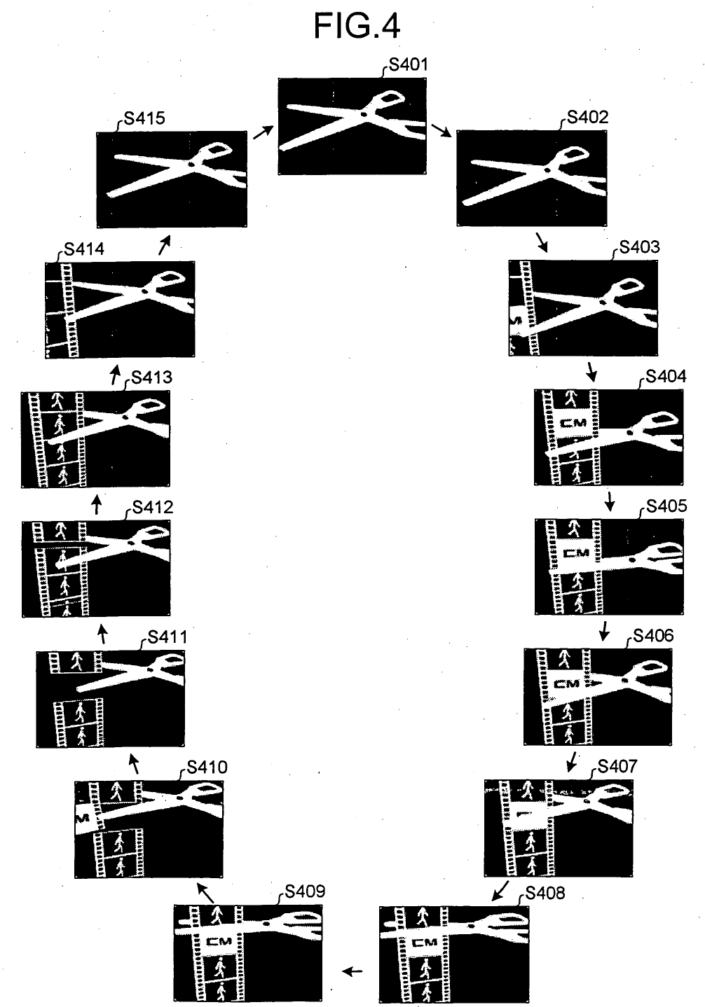

FIG. 4 to FIG. 8 are schematics of animated images. In FIG. 4, successive images (S401 to S415) composing an animated image that indicates an “editing” operation of data, for example, a recorded television program, is shown. In the animated image shown in FIG. 4, first, scissors are shown (S401 and S402), and then a film appears. A frame in the film is cut with the scissors (S403 to S409), and is extracted (S410). The film is joined (S411 to S414), and then, finally, only the scissors are shown again (S415).

By showing the animated image that displays cutting a film with scissors and joining the file, it is possible to let an operator intuitively recognize that the operation to be performed is the editing operation.

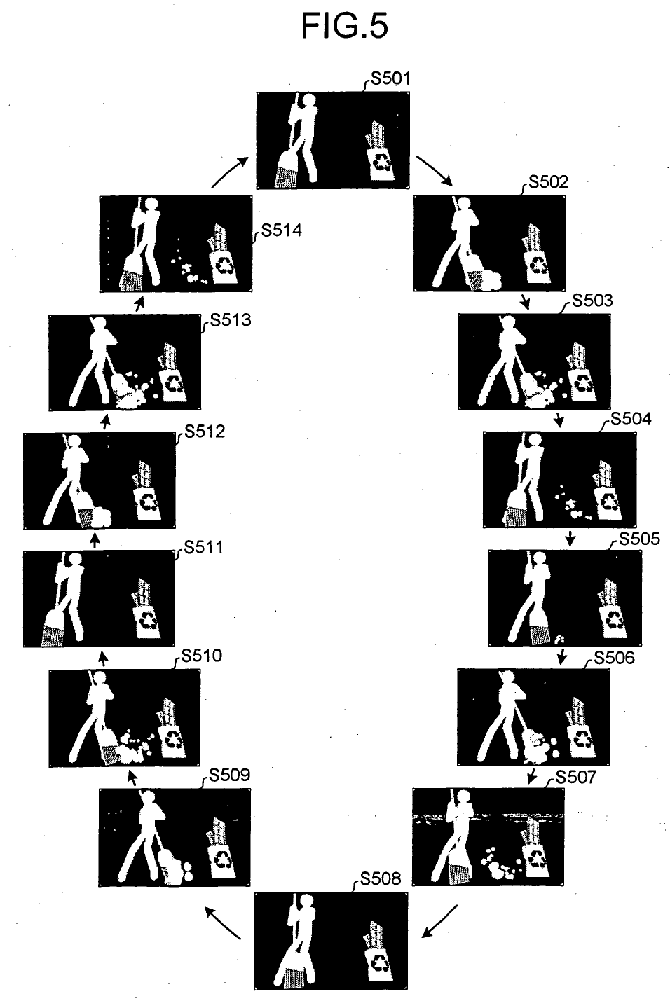

In FIG. 5, successive images (S501 to S514) composing an animated image that indicates a “deleting” operation of data in a DVD recorder/player is shown. In the animated image shown in FIG. 5, a person holding a broom is sweeping trash toward a trash bag containing discarded films. By showing such animated image, it is possible to let the operator intuitively recognize that the operation to be performed is the deleting operation to delete data, such as recorded television program.

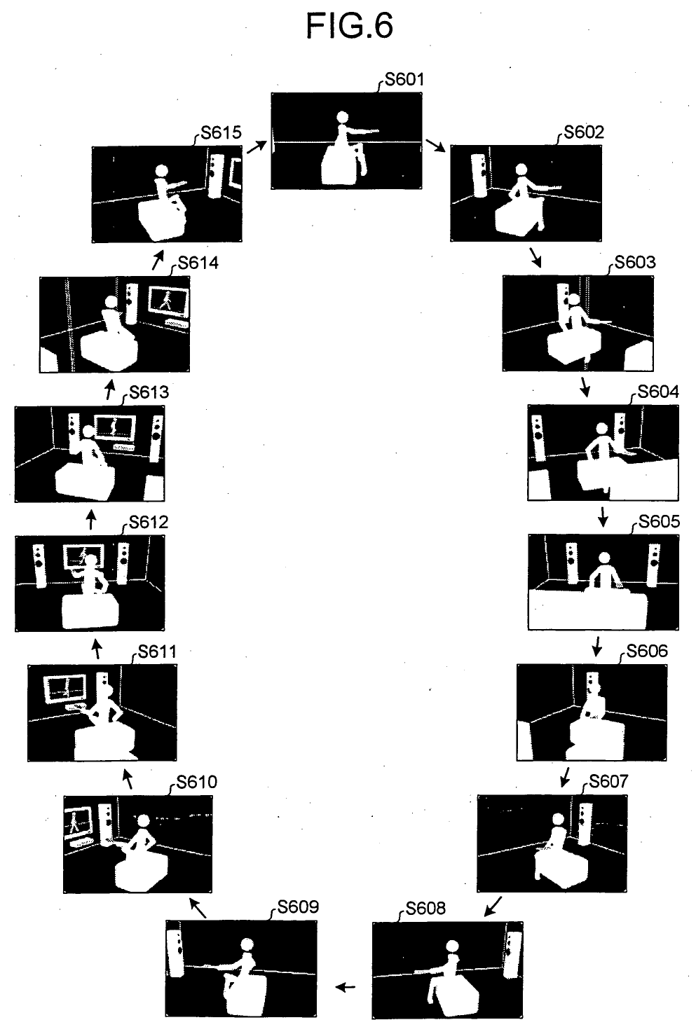

In FIG. 6, successive images (S601 to S615) composing an animated image that indicates a “various setting” operation in a DVD recorder/player. In the animated image shown in FIG. 6, a person sitting on a stool and holding a remote controller is shown from various angles as if such a movie is taken while turning a camera around the person. By showing the animated image that displays a person operating a remote controller, it is possible to let the operator intuitively recognize that the operation to be performed is the various settings operation to make various settings for the DVD recorder/player.

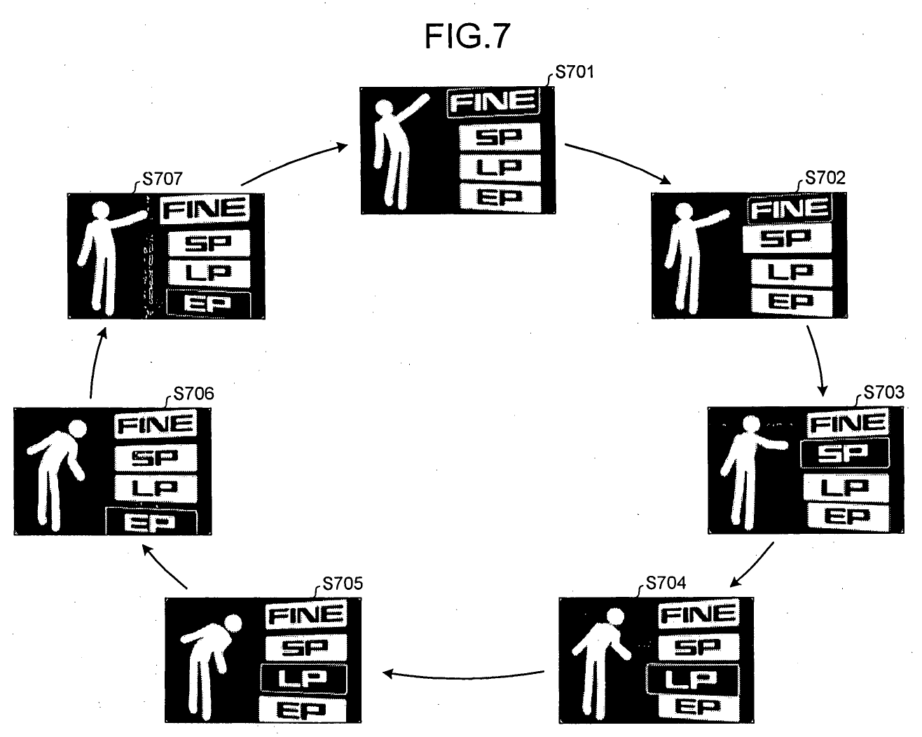

In FIG. 7, successive images (S701 to S707) composing an animated image that indicates an “image quality selecting” operation in the DVD recorder/player. In the animated image shown in FIG. 7, a person and boxes with abbreviated names, “FINE”, “SP”, “LP”, and “EP”, showing image quality types are shown. The person in the animated image points the boxes one by one.

Specifically, the person first points the uppermost box indicating a “FINE” mode (S701 and S702), then, points to the second box indicating an “SP” box mode (S703), the third box indicating an “LP” mode (S704 and S705), and finally the fourth (lowermost) box indicating an “EP” mode (S706). Then, the person again points the box indicating a “FINE” mode (S707), and the image returns to S701. In this case, for discriminating a pointed box from other boxes, the box is highlighted or colored in a different color from others.

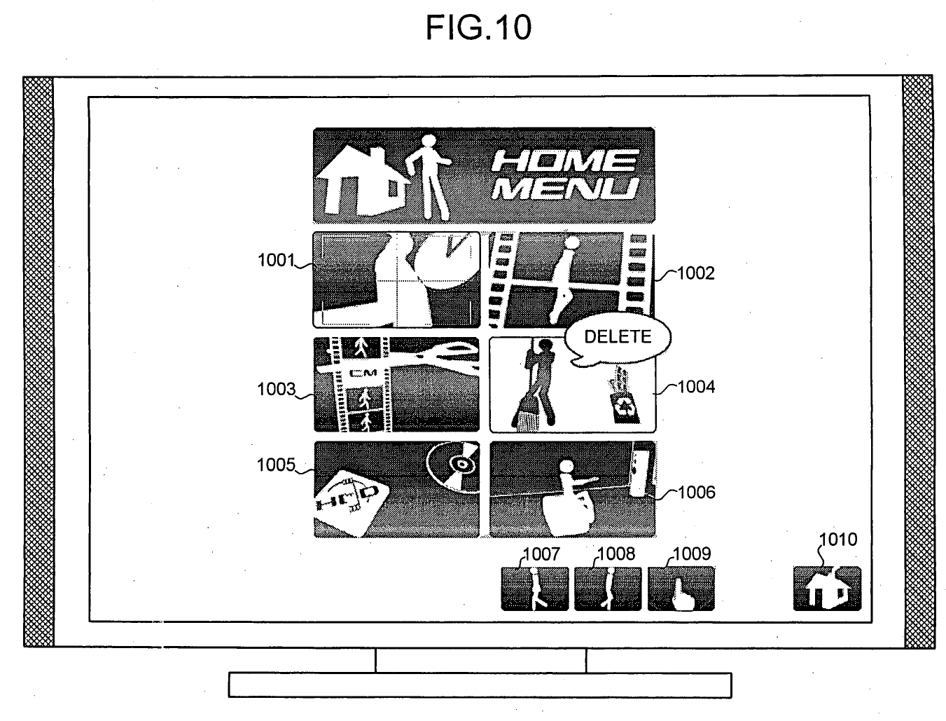

An operator selects a desirable image quality based on a state of the animated image. Specifically, if the operator presses a selection instructing button 1009 (see FIG. 10) in a state of in which the “FINE” box is, for example, highlighted (S701 and S702), the FINE mode is selected. Similarly, in a state of S703, the SP mode is selected, in a state of S704 or S705, the LP mode is selected, and in a condition of S706 or S707, the EP mode is selected.

As such, by showing such animated image, it is possible to let the operator intuitively recognize that the operation is the image quality selecting operation, and to easily select a desirable image quality.

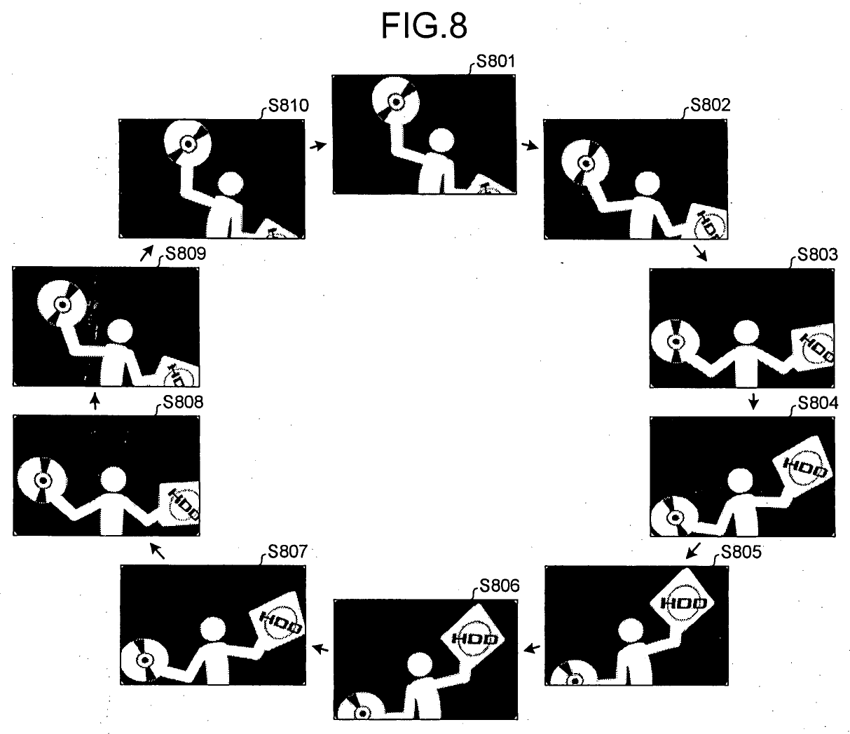

In FIG. 8, successive images (S801 to S810) composing an animated image that indicates a “recording destination selecting” operation in the DVD recorder/player. In the animated image shown in FIG. 8, a person is alternately holding up recording media, a hard disk and a DVD with both hands.

Specifically, the person first holds up the DVD in his/her right hand (S801) and gradually lowers the DVD while gradually raising the hard disk in his/her left hand (S802 to S805). Then, after holding up the hard disk in his/her left hand (S806), the person now gradually lowers the hard disk while again gradually raising the DVD in his/her right hand (S807 to S810), and the scene returns to S801.

An operator selects a desirable recording destination based on a state of the animated image. Specifically, if the operator presses the selection instructing button 1009 in a state in which the DVD is held up (S801 and S802), the DVD is selected as a recording destination. On the other hand, in a state of S804 to S807, the hard disk is selected as the recording destination, and in a state of S808 and S810, the DVD again is selected.

As such, by indicating an animated image where a person is made to hold a recording medium as selecting destinations and hold either upward, it becomes possible to allow an operator to intuitively recognize that the operation is a recording destination selecting operation and to easily select a recording destination.

Processing Procedures by Operation Instruction Device

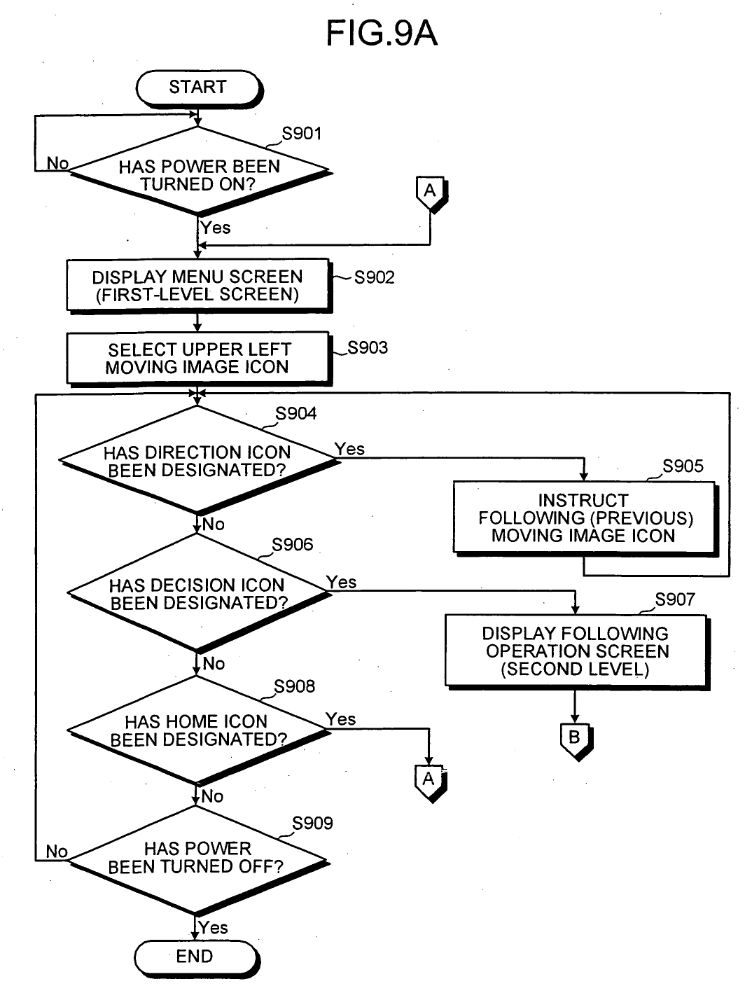

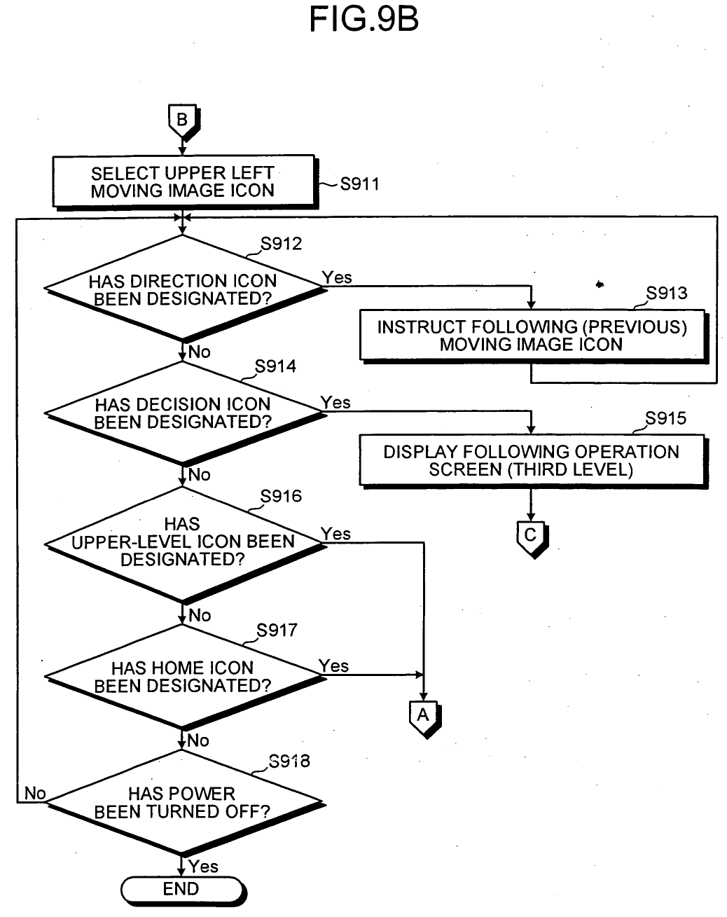

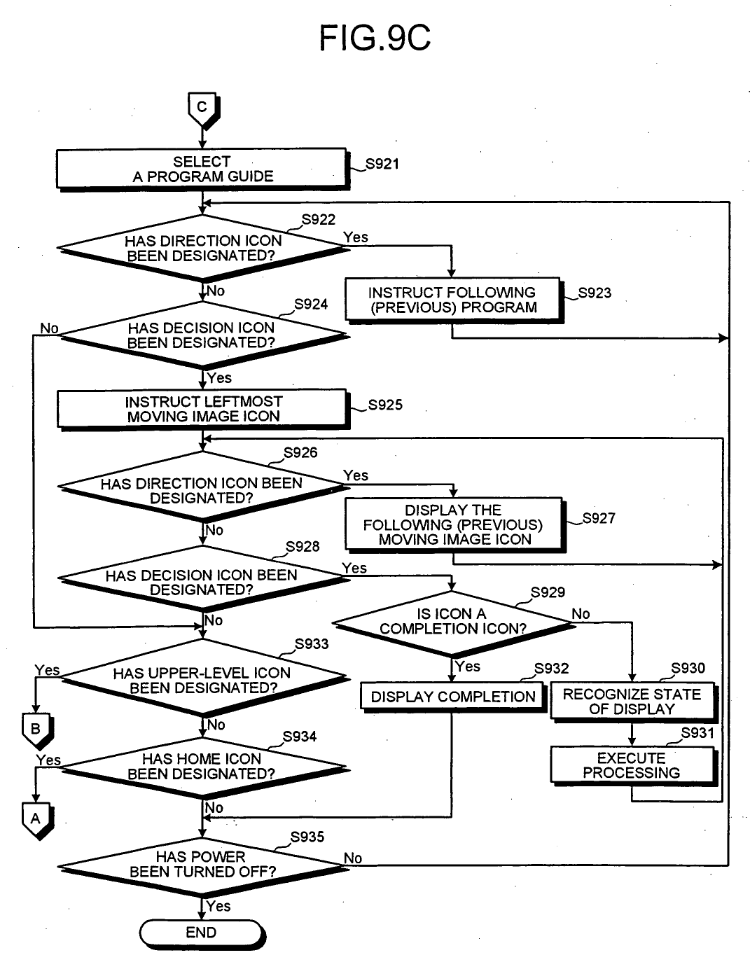

FIG. 9A to FIG. 9C are flowcharts of processings in the operation instruction device. As shown in FIG. 9A, the operation instruction device first judges whether the power of the DVD recorder/player has been turned on (step S901). When the power is turned on (“YES” at step), the operation instruction device displays a menu screen (first-level screen) (step S902). The menu screen is specifically a display screen shown in FIG. 10.

As shown in FIG. 10, the menu screen displays six animated images 1001 to 1006, a leftward-direction instructing button 1007, a rightward-direction instructing button 1008, the selection instructing button 1009, and a home-screen instructing button 1010. The animated image 1001 indicates a “recording” operation, the animated image 1002 indicates a “reproducing” operation, the animated image 1003 indicates the editing operation, the animated image 1004 indicates the “deleting” operation, the animated image 1005 indicates a “dubbing” operation, and the animated image 1006 indicates the “various setting” operation.

In addition, the leftward-direction instructing button 1007 expresses a person walking leftward by animation and thereby indicating instruction to shift in a leftward direction. Similarly, the rightward-direction instructing button 1008 expresses a person walking rightward by animation and thereby indicating instruction to shift in a rightward direction. The selection instructing button 1009 expresses a button being pressed by a finger and thereby indicates making a selection (selection instruction).

The home-screen instructing button 1010 expresses a house turning round, thereby indicating instruction to return to a home screen. Selected animated image is highlighted or displayed in a different color. Furthermore, when the animated image is selected, a name of the function thereof (“delete”) is displayed in a balloon.

Referring back to FIG. 9A, the operation instruction device displays the menu screen in a state in which an upper left animation icon (the animated image 1001) in FIG. 10) (step S903). Then, the operation instruction device judges whether a direction icon has been designated (the leftward-direction instructing button 1007 or rightward-direction instructing button 1008) (Step S904). When the direction icon has been designated (“YES” at step S904), in a case of the leftward-direction instructing button 1007, the previous animation icon (the animated image 1006) is selected (step S905), and then the process returns to step S904. Similarly, in a case of the rightward-direction instructing button 1008, the following animation icon (the animated image 1002) is instructed (step S905), and then the process returns to step S904.

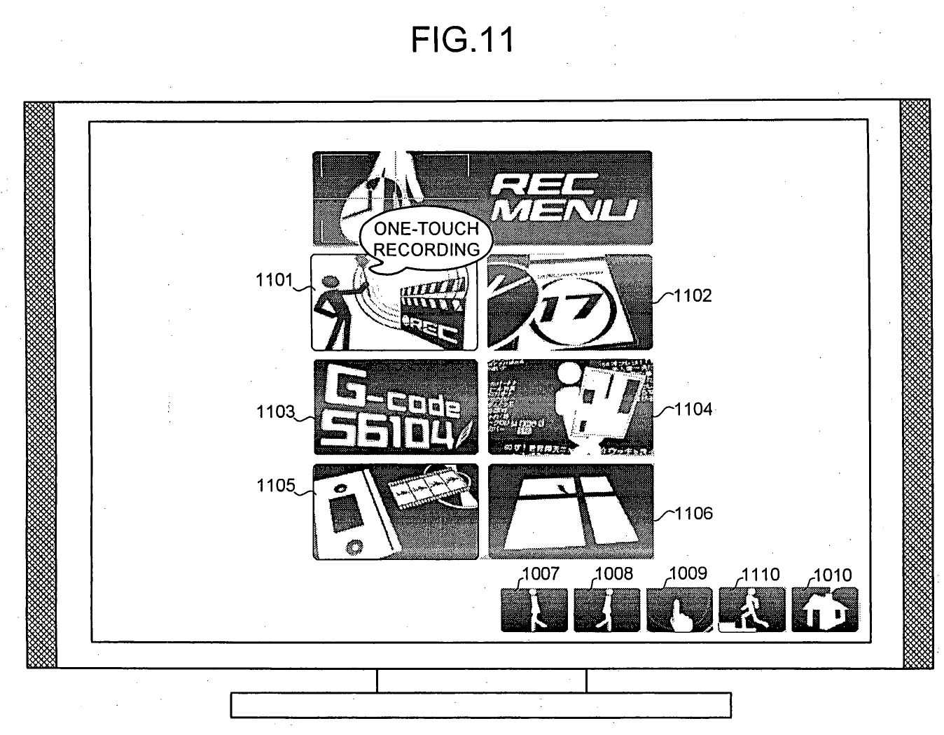

When no direction icon has been designated (“NO” at step S904), the operation instruction device next judges whether the selection instructing button 1009 is pressed (step S906). When the selection instructing button 1009 is pressed (“YES” at step S906), the following operation screen (second level) is displayed (step S907). Thereafter, the process shifts to step S911 shown in FIG. 9B. Specifically, a screen displayed when the animated image 1001 (“recording” operation) has been instructed as a second-level screen is a display screen shown in FIG. 11.

When the decision icon has not been designated (“NO” at step S906), the operation instruction device next judges whether the home-screen instructing button 1010 is pressed (step S908). When the home-screen instructing button 1010 is pressed (“YES” at step S908), the process returns to step S902. On the other hand, when the home-screen instructing button 1010 is not pressed (“NO” at step S908), the operation instruction device judges whether the power has been turned off (step S909), and when the power has not been turned off (“NO” at step S909), the process returns to step S904. On the other hand, when the power has been turned off (“YES” at step S909), the operation instruction device ends a series of processes.

Referring to FIG. 9B, the operation instruction device displays a second-level menu screen shown in a stated in which an upper left animation icon (animated image 1101 shown in FIG. 11) is selected (step S911).

A shown in FIG. 11, the recording menu screen is composed of six animated images (1101 to 1106), a leftward-direction instructing button 1007, the rightward-direction instructing button 1008, the selection instructing button 1009, the home-screen instructing button 1010, and furthermore, an upper-level-screen instructing button 1110. The upper-level-screen instructing button 1110 expresses a person going up stairs by animation, thereby indicating a shift to an upper-level screen. The animated image 1101 indicates a “one-touch recording” operation, the animated image 1102 indicates a “recording reservation” operation, the animated image 1103 indicates a “G-code reservation” operation, the animated image 1104 indicates a “program guide reservation” operation, the animated image 1105 indicates a “recording from video” operation, and the animated image 1106 indicates a “finalizing” operation.

Similarly to the home menu shown in FIG. 10, the animated image selected is highlighted or is displayed in a different color. Furthermore, when the animated image (animated image 1101) is selected, a name of the function (“one-touch recording”) is displayed in a balloon. The upper-level-screen instructing button 1110 is to instruct to display an upper-level display screen. In the home menu, the upper-level-screen instructing button 1110 is not displayed because a screen for the home menu is at the top of the hierarchical structure and an upper-level screen thereof does not exist.

Referring back to FIG. 9B, the operation instruction device judges whether a direction icon has been designated (the leftward-direction instructing button 1007 or rightward-direction instructing button 1008) at step S912. When the direction icon has been designated (“YES” at step S912), in a case of the leftward-direction instructing button 1007, the previous motion icon (the animated image 1106) is selected (step S913), and then the process returns to step S912. Similarly, in a case of the rightward-direction instructing button 1008, the following motion icon (the animated image 1102) is selected (step S913), and then the process returns to step S912.

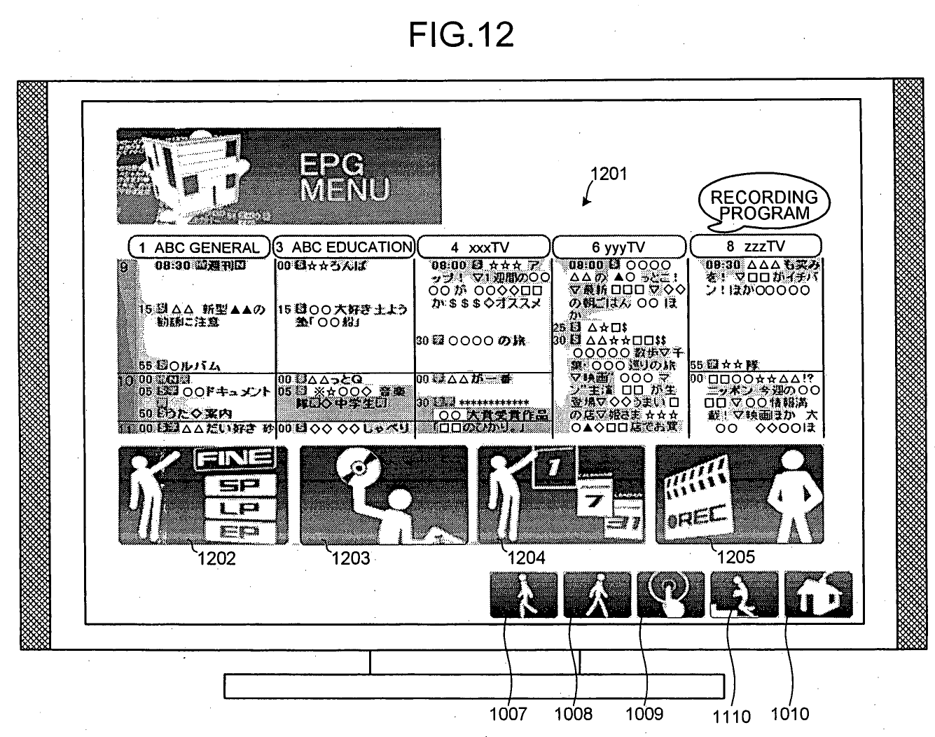

At step S912, when no direction icon has been designated (“NO” at step S912), the operation instruction device next judges whether the selection instructing button 1009 is pressed (step S914). When the selection instructing button 1009 is pressed (“YES” at step S914), the following operation screen (third level) is displayed (step S915). Thereafter, the process shifts to step S921 shown in FIG. 9C. For example, when the animated image 1104 (“program guide reservation” operation) is designated, such a screen shown in FIG. 12 is displayed as the third-level screen.

At step S914, when the selection instructing button 1009 is not pressed (“NO” at step S914), the operation instruction device next judges whether the upper-level-screen instructing button 1110 has been pressed (step S916). When the upper-level-screen instructing button 1110 has been pressed (“YES” at step S916), the process returns to step S902 shown in FIG. 9A. On the other hand, when the upper-level-screen instructing button 1110 is not pressed (“NO” at step S916), the operation instruction device next judges whether the home-screen instructing button 1010 has been pressed (step S917).

When the home-screen instructing button 1010 has been pressed (“YES” at step S917), the process returns to step S902. On the other hand, when the home icon has not been designated (“NO” at step S917), the operation instruction device judges whether the power has been turned off (step S918), and when the power has not been turned off (“NO” at step S918), the process returns to step S912. On the other hand, when the power has been turned off (“YES” at step S918), the operation instruction device ends a series of processes.

Referring to FIG. 9C, the operation instruction device, for example, displays a third-level menu screen that is, for example, a program recording screen shown in FIG. 12. The program recording screen is displayed in a state in which a television program guide 1201 is selected (step S921).

As shown in FIG. 12, the program recording screen is composed of the program guide 1201, four animated images (1202 to 1205), a leftward-direction instructing button 1007, the rightward-direction instructing button 1008, the selection instructing button 1009, the home-screen instructing button 1010, and the upper-level-screen instructing button 1110. The animated image 1202 indicates an “image quality selecting” operation, the animated image 1203 indicates a “recording destination selecting” operation, the animated image 1204 indicates a “recording time selecting” operation, and the animated image 1205 indicates a “reservation deciding” operation.

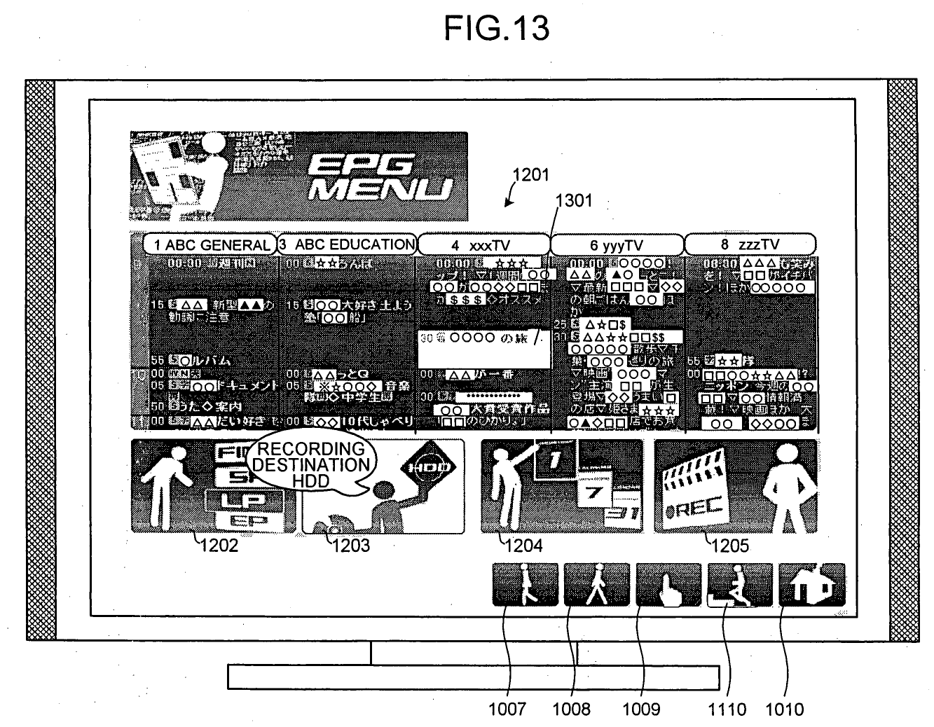

Similarly to the home menu shown in FIG. 10, the animated image selected is highlighted or is displayed in a different color. The same applies to the program guide 1201, and a selected program is highlighted or displayed in a different color. FIG. 13 illustrates a state of the program recording screen when a program 1301 is selected in the program guide 1201. Furthermore, when an animated image (animated image 1203) is selected, a name of the function thereof (“recording destination (selection)” is displayed in a balloon. In an example shown in FIG. 13, a selected recording destination (“HDD”) is also displayed. When the upper-level-screen instructing button 1110 is pressed, an upper-level display screen, which is the program recording menu screen, is displayed.

Referring back to FIG. 9C, the operation instruction device judges whether a direction icon has been designated (the leftward-direction instructing button 1007 or rightward-direction instructing button 1008 shown in FIG. 12 has been pressed) at step S922. When the direction icon has been designated (“YES” at step S922), in a case of the leftward-direction instructing button 1007, the previous program is selected (step S923), and then the process returns to step S922. Similarly, in a case of the rightward-direction instructing button 1008, the following program is selected (step S923), and then the process returns to step S922.

At step S922, when no direction icon is designated (“NO” at step S922), the operation instruction device next judges whether the selection instructing button 1009 is pressed (step S924). When the selection instructing button 1009 is not pressed (“NO” at step S924), the process shifts to step S933.

On the other hand, at step S924, when the decision icon has been designated (“YES” at step S924), the operation instruction device next selects a leftmost animation icon (animated image 1202 (“image quality selecting” operation in FIG. 13) (step S925). Then, the operation instruction device judges whether a direction icon has been designated (the leftward-direction instructing button 1007 or rightward-direction instructing button 1008) step S926). When the direction icon has been designated (“YES” at step S926), in a case of the leftward-direction instructing button 1007, the previous motion icon (that is, the animated image 1205 (“reservation deciding” operation)) is selected (step S927), and then the process returns to step S926. Similarly, in a case of the rightward-direction instructing button 1008, the following motion icon (that is, the animated image 1203 (“recording destination selecting” operation)) is selected (step S927), and then the process returns to step S926.

At step S926, when no direction icon has been designated (“NO” at step S926), the operation instruction device next judges whether the selection instructing button 1009 is pressed (step S928). When the selection instructing button 1009 is pressed (“YES” at step S928), the operation instruction device judges whether the selected icon is an icon that completes the operation (step S929), that is, the animated image 1205 (“reservation deciding” operation). When the icon is not such icon to complete the operation (“NO” at step S929), the operation instruction device recognizes a state of the display (step S930).

The state of the display is recognized for the animated image 1202 (“image quality selecting” operation), to determine which image quality is being displayed at the time of the selection instructing button 1009 being pressed. Based on the recognition, processing is executed (step S931). Specifically, when the selection instructing button 1009 is pressed when the “LP” is displayed, recording image quality is set to an LP mode. Accordingly, the operator can easily set to a desirable condition just by inputting designation during the desirable condition is displayed in the animated image.

When the process is executed, the animated image is frozen in a state in which a selected condition (“LP”) is displayed, and then, the process returns to step S926. Thus, by showing the selected condition in a freeze-frame image, the operator can easily recognize that an image quality selection has been completed. In addition, the operator can easily recognize which condition is actually selected. Therefore, it is possible to prevent the operator making wrong selection.

At step S928, when the decision icon has not been designated (“NO” at step S928), the operation instruction device judges whether the upper-level-screen instructing button 1110 has been pressed (step S933). When the upper-level-screen instructing button 1110 has been pressed (“YES” at step S933), the process returns to step S911 shown in FIG. 9B. On the other hand, when the upper-level-screen instructing button 1110 has not been pressed (“NO” at step S933), the operation instruction device judges whether the home-screen instructing button 1010 has been pressed (step S934).

At step S934, when the home-screen instructing button 1010 has been pressed (“YES” at step S934), the process returns to step S902. On the other hand, when the home-screen instructing button 1010 has not been pressed (“NO” at step S934), the operation instruction device judges whether the power has been turned off (step S935). When the power has not been turned off (“NO” at step S935), the process returns to step S922. On the other hand, when the power has been turned off (“YES” at step S935), the operation instruction device ends a series of processes.

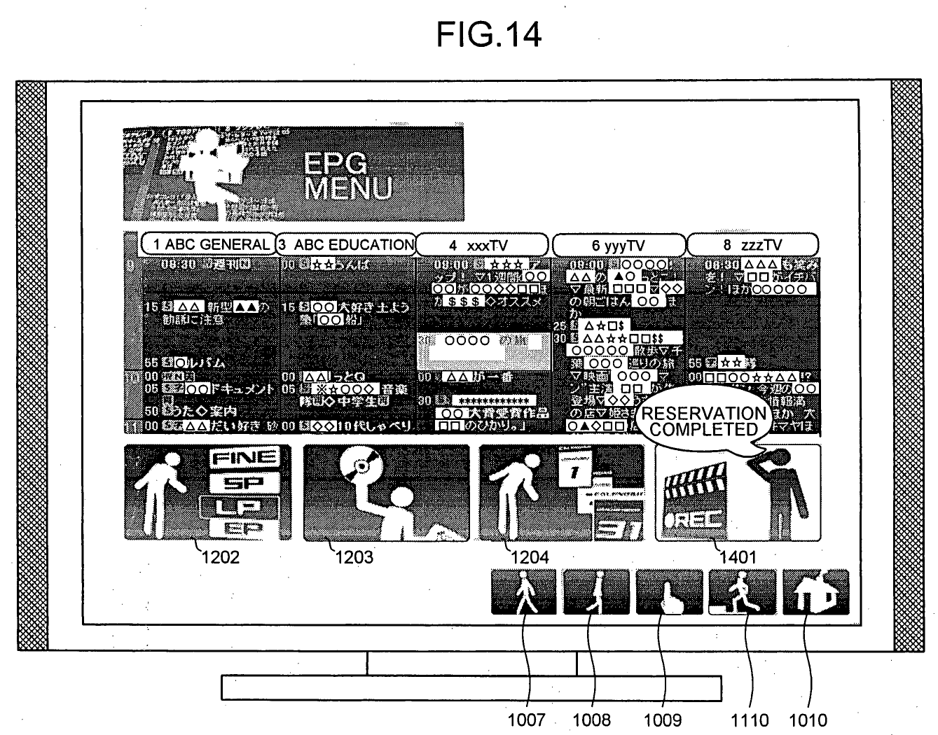

At step S929, when the icon is the icon to complete the operation (“YES” at step S929), specifically, when the icon is the animated image 1205 (“reservation deciding” operation), the operation instruction device displays a notice of completion (step S932), and then the process shifts to step S935. Specifically, as shown in an animated image 1401 of FIG. 14, a person that appears in the animated image salutes to indicate a reservation completion, and a “reservation completion” is displayed in a balloon. At the time of completion of the operation, if any of the animated images 1202 to 1204 shows a freeze-frame image without having been selected, the operation instruction device determines that a default condition has been selected or that a condition selected for an operation performed at previous time has also been selected this time, to complete the operation.

According to the operation instruction device according to an example of the present invention, by indicating contents of an alternative operations with an animated image, an operator can easily and intuitively recognize the contents of operation. Accordingly, even for an unaccustomed operation, the operator can easily and efficiently instruct the operation without referring to a help screen or a manual.

The operation instruction method can be realized by executing a program prepared in advance by a computer, such as a personal computer and a workstation. This program is recorded on a computer-readable recording medium, such as a hard disk, a flexible disk, a CD-ROM, an MO, and a DVD, and is executed by being read out from the recording medium by a computer. Moreover, the program may be a transmission medium that can be distributed via a network such as the Internet.

In the embodiment, an example of executing the operation instruction method in an operation instruction device that can be mounted on a vehicle has been explained. However, the operation instruction method can also be executed in another operation instruction device, such as a personal computer, a mobile phone, a personal digital assistance (PDA).

The present document incorporates by reference the entire contents of Japanese priority document, 2004-356626 filed in Japan on Dec. 9, 2004.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An operation instruction device comprising:
a display control unit configured to repeatedly display, on a display screen, at least one animation indicative of contents of an operation to be executed;
an accepting unit configured to accept designation of an animation from among the animation displayed; and
an executing unit configured to execute, based on the designation, an operation indicated by designated animation.

2. The operation instruction device according to claim 1, wherein
the executing unit is configured to execute an operation based on a state of display of the designated animation at the time of the accepting unit accepting the designation.

3. The operation instruction device according to claim 1, wherein
the display control unit is configured to freeze the designated animation based on a state of display of the designated animation at the time of the accepting unit accepting the designation.

4. The operation instruction device according to claim 1, wherein
the operation has a hierarchical structure, and
the display control unit is configured to display, if the operation indicated by the designated animation has at least one lower-level operation in the hierarchical structure, an animation indicating the lower-level operation.

5. The operation instruction device according to claim 1, wherein
the animation is configured so as to visually show the operation being performed by an operator.

6. The operation instruction device according to claim 5, wherein
the animation is configured to have contents in which any one of a person and an anthropomorphic animal appears as the operator.

7. The operation instruction device according to claim 1, wherein
the animation includes a cartoon.

8. An electronic device comprising the operation instruction device according to claim 1.

9. An operation instruction method comprising:
displaying, on a display screen, at least one animation indicative of contents of an operation to be executed, repeatedly;
accepting designation of an animation from among the animation displayed; and
executing, based on the designation, an operation indicated by designated animation.

10. The operation instruction method according to claim 9, wherein
the executing includes executing an operation based on a state of display of the designated animation at the time of accepting the designation.

11. The operation instruction method according to claim 9, further comprising
freezing the designated animation based on a state of display of the designated animation at the time of accepting the designation.

12. The operation instruction method according to claim 9, wherein
the operation has a hierarchical structure, and
the displaying includes displaying, if the operation indicated by the designated animation has at least one lower-level operation in the hierarchical structure, an animation indicating the lower-level operation.

13. The operation instruction method according to claim 9, wherein
the animation is configured so as to visually show the operation being performed by an operator.

14. The operation instruction device according to claim 9, wherein
the animation includes a cartoon.

15. A computer-readable recording medium that stores therein a computer program for realizing an operation instruction method, the computer program making a computer execute:
displaying, on a display screen, at least one animation indicative of contents of an operation to be executed, repeatedly;
accepting designation of an animation from among the animation displayed; and
executing, based on the designation, an operation indicated by designated animation.

16. The computer-readable recording medium according to claim 15, wherein
the executing includes executing an operation based on a state of display of the designated animation at the time of accepting the designation.

17. The computer-readable recording medium according to claim 15, wherein the computer program further makes the computer execute
freezing the designated animation based on a state of display of the designated animation at the time of accepting the designation.

18. The computer-readable recording medium according to claim 15, wherein
the operation has a hierarchical structure, and
the displaying includes displaying, if the operation indicated by the designated animation has at least one lower-level operation in the hierarchical structure, an animation indicating the lower-level operation.

19. The computer-readable recording medium according to claim 15, wherein
the animation is configured so as to visually show the operation being performed by an operator.

20. The computer-readable recording medium according to claim 15, wherein
the animation includes a cartoon.
